(19) United States
(12) Patent Application Publication
(10) Pub. No.: US 2002/0192555 A1
(43) Pub. Date: Dec. 19, 2002

(54) Non-aqueous electrolyte secondary battery

(75) Inventors: Minoru Teshima, Kyoto-shi (JP); Toru Tabuchi, Kyoto-shi (JP)

Correspondence Address: SUGHRUE MION, PLLC, 2100 PENNSYLVANIA AVENUE, N.W., WASHINGTON, DC, 20037, US

(73) Assignee: JAPAN STORAGE BATTERY CO., LTD.

(21) Appl. No.: 10/131,078

(22) Filed: Apr. 25, 2002

(30) Foreign Application Priority Data
Apr. 26, 2001 (JP) P. 2001-130043

(51) Int. Cl. H01M 4/58; H01M 4/50; H01M 4/52

(52) U.S. Cl. 429/231.8; 429/231.1; 429/231.3; 429/223; 429/224

(57) ABSTRACT

The non-aqueous electrolyte secondary battery comprising a positive electrode comprising a positive active material capable of absorbing/releasing lithium ion and a negative electrode comprising as a negative active material a graphite comprising boron having a S1/S2 ratio of about 1.0 or less wherein S1 is the area of the peak having its top at a range of from 188 to 192 eV and S2 is the area of the peak having its top at a range of from 185 to 187 eV as measured by X-ray photoelectron spectroscopy (XPS). The content of boron in the graphite is from about 0.008% to about 3% by weight. The boron-containing graphite incorporated as a negative active material contains little boron compound having an extremely low electronic conductivity, and the discharge capacity of the non-aqueous electrolyte secondary battery can be enhanced.

### FIELD OF THE INVENTION

The present invention relates to a non-aqueous electrolyte secondary battery.

### BACKGROUND OF THE INVENTION

A lithium secondary battery as a non-aqueous electrolyte secondary battery has been put to practical use mainly in the field requiring small-sized lightweight batteries. For this lithium secondary battery, the positive electrode material has been firstly studied in detail. As a result, it was found that lithium cobalt oxide (LiCoO₂) is useful as a positive electrode material.

However, the lithium secondary battery at that time used lithium metal as a negative active material and thus was disadvantageous in that as the lithium metal repeatedly undergoes charging and discharging, it grows locally in the form of branch to cause capacity drop and pierces the separator to cause internal shortcircuiting. Therefore, the utilization of lithium alloy instead of lithium metal was proposed. However, this proposal had difficulty in cycle life performance and energy density.

Accordingly, the lithium secondary battery which is practically used at present comprises as a negative active material a carbonaceous material which can have lithium ion intercalated therein or deintercalated therefrom. Among these carbonaceous materials, a graphite containing boron exhibits an extremely high crystallinity and thus is expected to be able to enhance the capacity of the lithium secondary battery.

However, in the non-aqueous electrolyte secondary battery comprising a graphite containing boron as a negative active material, the condition of presence of boron in the negative active material is an important factor. Thus, this non-aqueous electrolyte secondary battery was disadvantageous in that its discharge capacity decreases depending on the condition of presence of boron. In other words, when the graphite containing boron has a high boron content, boron cannot form solid solution with the graphite during graphitization, causing a boron compound to be attached to the surface of the active material and hence lowering the electronic conductivity thereof. Accordingly,-the electronic conductivity between the active materials in the negative composite and between the active material and the current collector is lowered, resulting in the decrease in the discharge capacity of the battery.

Therefore, the present invention is to enhance the discharge capacity of a non-aqueous electrolyte secondary battery comprising a graphite containing boron.

### SUMMARY OF THE INVENTION

The non-aqueous electrolyte secondary battery of the invention comprises the following elements. That is, it comprises a positive electrode comprising a positive active material capable of absorbing and releasing lithium ion and a negative electrode comprising as a negative active material a graphite comprising boron having a S1/S2 ratio of about 1.0 or less wherein S1 is the area of the peak having its top at a range of from 188 to 192 eV and S2 is the area of the peak having its top at a range of from 185 to 187 eV as measured by X-ray photoelectron spectroscopy (XPS). The content of boron in the graphite is from about 0.008% by weight to about 3% by weight. In the non-aqueous electrolyte secondary battery of the present invention, the boron-containing graphite incorporated as a negative active material contains almost no boron compound showing an extremely low electronic conductivity. Thus, the discharge capacity of the non-aqueous electrolyte secondary battery of the present invention can be enhanced.

Further, the positive active material is preferably LiₓMO₂ wherein M represents one or more transition metals selected from the group consisting of Co, Ni and Mn, and x is from 0.1 to 1.2 (0.1≦×≦1.2) or LiₓMn₂O₄ wherein x is from 0.1 to 1.2 (0.1≦×≦1.2).

Moreover, boron in the graphite is preferably one derived from boric acid.

### BRIEF DESCRIPTION OF THE DRAWINGS

FIG. 1 illustrates a sectional view of a prismatic non-aqueous electrolyte secondary battery according to an embodiment of implication of the invention;

FIG. 2 illustrates an example of the B1s spectrum of X-ray photoelectron spectroscopy (XPS) of a graphite containing boron; and

FIG. 3 illustrates peaks A and B separated from each other by Gaussian waveform function.

### DETAILED DESCRIPTION OF THE INVENTION

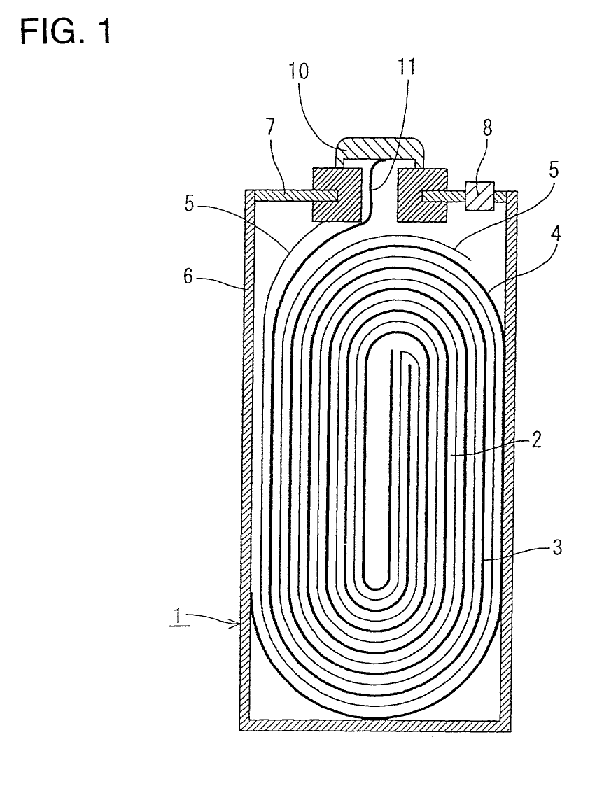

An embodiment of implication of the present invention will be described hereinafter in connection with the drawings. FIG. 1 is a sectional view of a prismatic non-aqueous electrolyte secondary battery according to an embodiment of implication of the present invention. The prismatic non-aqueous electrolyte secondary battery 1 is obtained by receiving a flat wound electrode block 2 formed by winding a positive electrode 3 and a negative electrode 4 with a separator 5 interposed therebetween and a non-aqueous electrolyte containing an electrolytic salt (not shown) in a battery case 6.

A battery cover 7 provided with a safety valve 8 is laser-welded to the battery case 6. A positive electrode terminal 10 is connected to the positive electrode 3 via a positive electrode lead 11. The negative electrode 4 comes in contact with the inner wall of the battery case 6 to make electrical connection therebetween.

The negative electrode 4 comprises a negative active material layer comprising a negative composite provided on both sides of a current collector of negative electrode made of, e.g., copper, nickel or stainless steel.

The negative electrode 4 is produced, e.g., by the following method. A negative active material is mixed with a binder such as polyvinylidene difluoride to obtain a negative composite. This negative composite is then dispersed in a solvent such as N-methyl-2-pyrrolidone to obtain a slurry. This slurry is applied to both sides of a current collector of negative electrode, dried, and then compressed and smoothened by a roll press or the like to produce the negative electrode 4.

In the present invention, the negative electrode comprises a graphite containing boron incorporated therein as a negative active material. The graphite containing boron exhibits an enhanced crystallinity due to the catalytic action of boron in the step of graphitization. Therefore, the discharge capacity of the non-aqueous electrolyte secondary battery is considered to have an enhanced discharge capacity.

However, when the inventors made a detailed study by X-ray photoelectron spectroscopy (XPS), it was made clear that the discharge capacity changes with the state of presence of boron in the graphite.

In other words, it was made clear that boron needs to be in the form of solid solution in the graphite to increase the discharge capacity.

On the other hand, it was made clear that even if a graphite containing boron is used, production of a boron compound having an extremely low electronic conductivity such as B₂O₃ in the step of graphitization, and then attached to the surface of the negative active material, rather lowers the discharge capacity. In particular, it was made clear that this boron compound is attached to the surface of the negative active material to lower the electronic conductivity between negative active materials in the negative composite and between negative active material and current collector, resulting in the reduction of discharge capacity.

Therefore, in the present invention, the condition of presence of boron in the graphite is observed by X-ray photoelectron spectroscopy (XPS), whereby a graphite in which boron forms a solid solution is selected and used to enhance discharge capacity.

In some detail, a graphite containing boron having a S1/S2 ratio of about 1.0 or less wherein S1 is the area of the peak having its top at a range of from 188 to 192 eV and S2 is the area of the peak having its top at a range of from 185 to 187 eV as measured by X-ray photoelectron spectroscopy (XPS) is used to enhance discharge capacity.

A method for calculating the peak area S1 and the peak area S2 will be described hereinafter. Firstly, the principle of the method for determining the quantity of compound by X-ray photoelectron spectroscopy (XPS) will be described. The determination method by X-ray photoelectron spectroscopy (XPS) is described in detail in “Library of Surface Analysis Technology: X-ray Photoelectron Spectroscopy”, compiled by The Surface Science Society of Japan, published by Maruzen, July 1996, pp. 118-121. In accordance with this reference, the determination by XPS is practically carried out by the use of a relative sensitivity factor (RSF) method, and there are a case where a reference sample of sensitivity factor is used and a case where the measurement of reference sample is not effected. In the latter case, if the peak intensity of all elements present in an unknown sample are measured, the specified concentration X₁ is represented by the following equation:

X₁=(Iᵢ/Sⱼ)/(Σ(Iⱼ/Sⱼ))

wherein Iᵢ represents the photoelectron peak intensity of the sample of element i; and Sᵢ represents RSF of element i. Sᵢ is defined by the equation Sᵢ=Iᵢ^{pure}/I_{key} in which key represents the reference element of sensitivity factor. Σ(Iⱼ/Sⱼ) represents the sum of Iⱼ/Sⱼ wherein j is from 1 to n. For example, when j is 1, the element is carbon, when j is 2, the element is boron, and so on.

The invention utilizes a mechanism that elements of the same kind but having different states of bonding are observed to have a plurality of peaks corresponding to these states of bonding by X-ray photoelectron spectroscopy (XPS) and the ratio of the intensity of these peaks indicates the ratio of the elements having different states of bonding.

The method for calculating the area S1 and the area S2 of the invention will be described in detail below. Unlike the aforementioned ordinary determination method, the method of the invention employs peak area instead of the photoelectron peak intensity Iᵢ of the reference sample.

The following description will be made in-connection with the B1s spectrum of X-ray photoelectron spectroscopy (XPS) of graphite containing boron using AXIS-HS produced by Shimadzu Corp./KRATOS. For this measurement, MgKα ray was used as an X-ray source. The output of X-ray was 15 kV-15 mA. The correction of electrification was carried out by the use of C1s spectrum of graphite (284.5 eV).

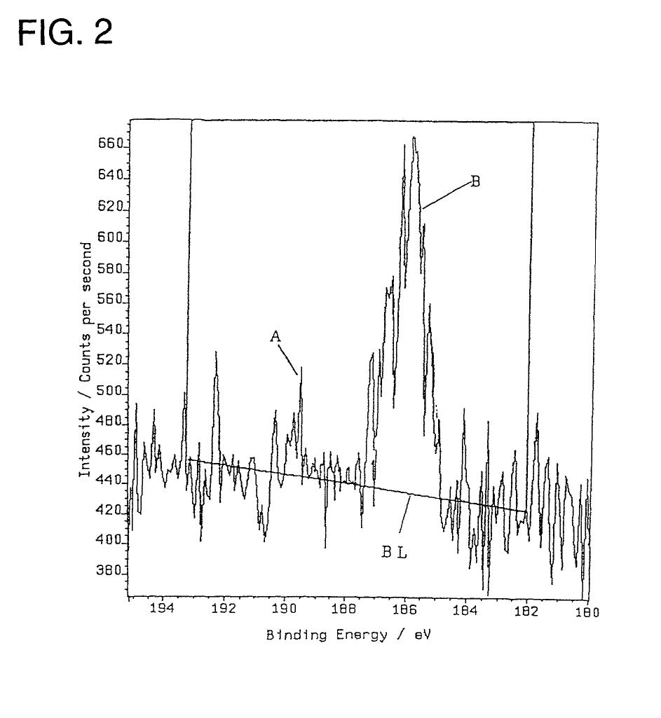

FIG. 2 illustrates an example of the B1s spectrum of X-ray photoelectron spectroscopy (XPS) of a graphite containing boron. In FIG. 2, the abscissa indicates binding energy and the ordinate indicates intensity, i.e., number of photoelectrons detected. Further, in FIG. 2, A indicates the peak having its top at a range of from 188 to 192 eV, B indicates the peak having its top at a range of from 185 to 187 eV, and BL indicates the base line. As can be seen in FIG. 2, many small peaks appear on XPS spectrum. It is thus difficult to determine the peak area from this spectrum.

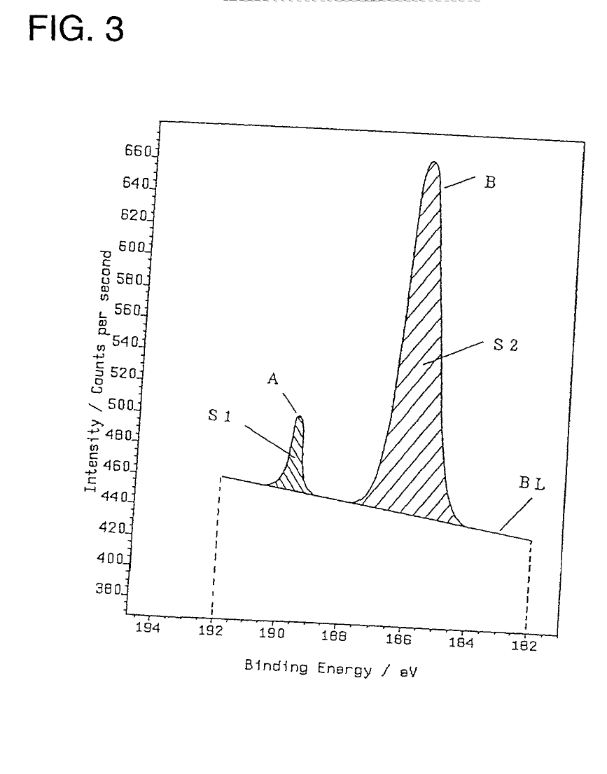

Only peaks A and B which are separated by Gaussian waveform function are picked up and shown in FIG. 3. In FIG. 3, the symbols A, B and BL are as defined in FIG. 2, S1 indicates the area of peak A having its top at a range of from 188 eV to 192 eV, and S2 indicates the area of peak B having its top at a range of from 185 eV to 187 eV. In the invention, the ratio S1/S2 of the area S1 of peak A shown hatched in FIG. 3 to the area S2 of peak B shown hatched in FIG. 3 is not greater than about 1.0.

The peak B having its top at a range of from 185 eV to 187 eV indicates the peak corresponding to mainly the boron that formed a solid solution in the carbonaceous material, and the peak A having its top at a range of from 188 eV to 192 eV indicates the peak corresponding to a boron compound having an extremely low electronic conductivity. Therefore, S1/S2 can be used as an index for the ratio of concentration of boron compound having an extremely low electronic conductivity to the boron that formed a solid solution.

As a result of detailed study by the inventors, it was found that when S1/S2 is about 1.0 or less, the discharge capacity is enhanced. This is presumably because when S1/S2 is about 1.0 or less, the proportion of the boron compound having an extremely low electronic conductivity based on the boron that formed a solid solution on the surface of the graphite containing boron is low, enhancing the discharge capacity. On the contrary, when S1/S2 is about 1.0 or more, the proportion of the boron compound having an extremely low electronic conductivity based on the boron that formed a solid solution on the surface of the graphite containing boron is great, lowering the discharge capacity.

S1/S2 is preferably about 1.0 or less, more preferably about 0.5 or less, particularly preferably about 0.1 or less.

In the present invention, the content of boron in the graphite is from about 0.008% by weight to about 3% by weight based on the total weight of the boron and the graphite. This is because when the content of boron in the graphite is from about 0.008% by weight to about 3% by weight, boron forms a complete solid solution in the graphite to obtain a non-aqueous electrolyte secondary battery having a very great discharge capacity. On the contrary, this is because when the content of boron in the graphite is greater than about 3% by weight, it is likely that boron which cannot form a solid solution can exist, lowering somewhat the discharge capacity of the non-aqueous electrolyte secondary battery.

When the content of boron in graphite increases, a boron compound covers the surface of the graphite, occasionally lowering the electronic conductivity as previously mentioned. From this standpoint of view, it is practical to lower the boron content and hence the peak ratio S1/S2, enhancing the discharge capacity. Accordingly, the content of boron in the graphite is more preferably from about 0.01% by weight to about 2.5% by weight, particularly preferably from about 0.01% by weight to about 2.0% by weight.

A process for the production of the graphite containing boron of the invention will be described hereinafter. The graphite containing boron is obtained by mixing a material free of boron and a material containing boron, and then subjecting the mixture to heat treatment at a temperature of, e.g., from about 2,000° C. to about 3,000° C. in an inert atmosphere. The crystallinity and peak ratio S1/S2 of the graphite containing boron can be adjusted by the temperature and time of the heat treatment (e.g., from about 20 hours to 1000 hours) and the cooling rate after heat treatment (e.g., from about 5° C./hr to about 40° C./hr).

As the material free of boron there may be used a coal-based or petroleum-based heavy materials such as oil tar and oil pitch, pitch coke, coal coke, petroleum coke, carbon black, pyrolytic carbon, organic resin material, natural graphite, artificial graphite or the like. On the other hand, the material containing boron is not specifically limited. For example, boron, boric acid (H₃BO₃), boron oxide (B₂O₃, B₄O₅), boron carbide (B₄C), etc. may be used. Further, the mixture which has been subjected to heat treatment may be then subjected to grinding and classification to adjust its particle size distribution to a predetermined value.

The inert atmosphere in which the heat treatment is effected is preferably an argon atmosphere or nitrogen atmosphere (or reducing gas atmosphere), particularly argon atmosphere. This is because impurities can be difficultly produced in an argon atmosphere while nitrides can be produced in a nitrogen atmosphere.

This heat treatment provides the graphite containing boron with a high crystallinity, preferably such that the average spacing between 002 planes (d₀₀₂) and the crystallite thickness in the direction of perpendicular to 002 plane (Lc) are from 0.335 to 0.340 nm and 50 nm or more, respectively, as determined by X-ray diffraction method using CuK′ ray. Referring to the particle diameter of the graphite containing boron, the particle diameter is preferably distributed within a range of from 0.1 μm to 150 μm, and BET specific surface area thereof is preferably from 0.2 to 10 m²/g.

The positive electrode 3 comprises a positive composite layer containing a positive active material capable of absorbing/releasing lithium ion provided on both sides of a current collector of positive electrode made of, e.g., aluminum, nickel or stainless steel.

The positive active material is not specifically limited and any compound may be used as long as it is a compound which absorbs/releases lithium or lithium ion. Examples of such a compound include LiₓMO₂ wherein M represents one or more transition metals selected from the group consisting of Co, Ni and Mn, and x is from 0.1 to 1.2 (0.1≦×≦1.2), LiMn₂O₄ wherein x is from 0.1 to 1.2 (0.1≦×≦1.2), etc. From the standpoint of magnitude of discharge voltage, among these compounds, LiₓMO₂ wherein M represents one or more transition metals selected from the group consisting of Co, Ni and Mn, and x is from 0.1 to 1.2 (0.1≦×≦1.2) is preferably used. As the positive active material there may be used a single compound or two or more compounds in admixture.

As the non-aqueous electrolyte of the invention, any of non-aqueous electrolyte and solid electrolyte may be used. The non-aqueous electrolyte, if used, is not specifically limited. For example, ethylene carbonate, propylene carbonate, butylene carbonate, trifluoropropylene carbonate, γ-butyrolactone, sulfolane, 1,2-dimethoxyethane, 1,2-diethoxyethane, tetrahydrofurane, 2-methyltetrahydrofurane, 3-methyl-1,3-dioxolane, methyl acetate, ethyl acetate, methyl propionate, ethyl propionate, dimethyl carbonate, diethyl carbonate, ethyl methyl carbonate, dipropyl carbonate, methyl propyl carbonate, etc. may be used singly or in admixture.

The lithium salt is not specifically limited. For example, LiClO₄, LiAsF₆, LiPF₆, LiBF₄, LiAsF₆, LiCF₃CO₂, LiCF₃SO₃, LiCF₃CF₂SO₃, LiCF₃CF₂CF₂SO₃, LiN (CF₃SO₂)₂, LiN (CF₂CF₃SO₂)₂, LiN (CF₃CO)₂ and LiN (CF₂CF₃CO)₂ may be used singly or in admixture.

As the solid electrolyte, a known organic solid electrolyte or inorganic solid electrolyte may be used. As the organic solid electrolyte, solid ionically-conductive polymer electrolyte or the like may be used. When this polymer electrolyte is formed by a polyethylene oxide, polyacrylonitrile, polyethylene glycol or modification product thereof, it has a light weight and is flexible, making it easy to produce a spiral electrode. Further, the polymer electrolyte and the non-aqueous electrolyte can be used in combination. As the solid electrolyte, there may be used, e.g., inorganic solid electrolyte, mixture of polymer electrolyte and inorganic solid electrolyte, inorganic solid powder bound with an organic binder besides the polymer electrolyte.

The separator 5 is not specifically limited. For example, a known woven fabric, nonwoven fabric, microporous synthetic resin film or the like. Particularly, a microporous synthetic resin film is preferably used. In particular, a microporous polyolefin film such as microporous polyethylene film, microporous polypropylene film and microporous film obtained by complexing these films is preferably used from the standpoint of thickness, film strength, film resisitivity, etc. When a polymer electrolyte is used as the electrolyte, this polymer electrolyte also acts as a separator.

The shape of the non-aqueous electrolyte secondary battery is not specifically limited and may be any of cylinder, prism, coin, button, sheet, etc.

### EXAMPLES AND COMPARATIVE EXAMPLES

Examples of the invention will be described hereinafter, but the invention is not limited thereto.

A prismatic non-aqueous electrolyte secondary battery 1 of FIG. 1 comprising lithium cobalt oxide as a positive active material and a carbonaceous material as a negative active material was produced.

Firstly, a positive electrode sheet was produced. 90 parts by weight of LiCoO₂ as an active material and 5 parts by weight of acetylene black as an electrically-conducting material were mixed. To the mixture were then added 5 parts by weight of a polyvinylidene difluoride (PVdF) as a binder to obtain a positive composite. To this positive composite was then added N-methyl-2-pyrrolidone (NMP) as a solvent. The mixture was then kneaded to prepare a slurry-like positive composite coating solution. Subsequently, this positive composite coating solution was successively applied to the both sides of an aluminum foil having a width of 26 mm, a length of 480 mm and a thickness of 20 μm in such an amount that the amount of the positive composite reached 2.3 g/100 cm on each side.

Subsequently, a negative electrode sheet was prepared. 90 parts by weight of the graphite set forth in Table 1 as a negative active material and 10 parts by weight of PVdF as a binder were mixed to obtain a negative composite. To this negative composite was then added NMP as a solvent. The mixture was then kneaded to prepare a slurry-like negative composite coating solution. Subsequently, the slurry-like negative composite coating solution was successively applied to the both sides of a copper foil having a width of 27 mm, a length of 530 mm and a thickness of 10 μm in such an amount that the amount of the negative composite reached 1.1 g/100 cm² on each side. The peak ratio set forth in Table 1 indicates the ratio S1/S2 of the area S1 of the peak having its top at a range of from 188 to 192 eV to the area S2 of the peak having its top at a range of from 185 to 187 eV as measured by X-ray photoelectron spectroscopy (XPS).

The positive electrode sheet and the negative electrode sheet were then compressed by a roll press such that the thickness thereof reached 165 μm and 170 μm, respectively. As the separator, there was used a microporous polyethylene film having a thickness of 25 μm. As the electrolyte, there was used a non-aqueous electrolyte obtained by dissolving LiPF₆ in a 1:1 mixture (by volume) of ethylene carbonate (EC) and diethyl carbonate (DEC) in an amount of 1.0 M. The aforementioned constituent elements were used to prepare a prismatic non-aqueous electrolyte secondary battery having a width of 30 mm, a height of 48 mm and a thickness of 5.15 mm.

Thus, 10 cells were prepared for each of a total of 9 types of prismatic non-aqueous electrolyte secondary batteries of Examples 1 to 5 and Comparative Examples 1 to 4 comprising graphites having different boron contents (% by weight) and peak ratios (S1/S2). In Comparative Example 3, a graphite free of boron was used.

TABLE 1

| | Boron content | Peak ratio |
|---|---|---|
| | (% by weight) | (S1/S2) |
| Example 1 | 3.0 | 0.1 |
| Example 2 | 3.0 | 0.5 |
| Example 3 | 3.0 | 1.0 |
| Example 4 | 1.5 | 0.5 |
| Example 5 | 0.01 | 0.5 |
| Comparative Example 1 | 3.0 | 1.5 |
| Comparative Example 2 | 1.5 | 1.5 |
| Comparative Example 3 | 0 | — |
| Comparative Example 4 | 4.0 | 0.5 |

These non-aqueous electrolyte secondary batteries were each subjected to constant current-constant voltage charging to 4.2 V with a current of 1C mA at 25° C. for 3 hours to reach fully charged state. Subsequently, these batteries were each discharged to 2.75 V with a current of 1C mA. At this time, these batteries were each measured for discharge capacity (hereinafter referred to as “initial discharge capacity (mAh)”). The results are set forth in Table 2. In Table 2, the initial discharge capacity of the various batteries each are the value averaged over 10 cells for each.

TABLE 2

| | Initial discharge capacity |
|---|---|
| | (mAh) |
| Example 1 | 709 |
| Example 2 | 682 |
| Example 3 | 660 |
| Example 4 | 652 |
| Example 5 | 645 |
| Comparative Example 1 | 563 |
| Comparative Example 2 | 560 |
| Comparative Example 3 | 620 |
| Comparative Example 4 | 562 |

From Table 2, the following facts were made obvious. The battery of Example 1, which comprises a graphite having a boron content of 3% by weight and a peak ratio of 0.1, exhibited a high discharge capacity as compared with the battery of Comparative Example 3, which comprises a graphite free of boron. This is presumably because the battery of Example 1 has little boron compound having an extremely low electronic conductivity present therein and boron is in the form of solid solution with the graphite to exhibit an improved electronic conductivity between the negative active materials in the negative composite and between the negative active material and the current collector.

The battery of Example 2, which has a boron content of 3% by weight and a peak ratio of 0.5, and the battery of Example 3, which has a boron content of 3% by weight and a peak ratio of 1.0, didn't show discharge capacity increase as much as that of Example 1 but showed a high discharge capacity as compared with the battery of Comparative Example 3, which comprises a graphite free of boron, for the same reason as in Example 1.

The battery of Example 4, which has a boron content of 1.5% by weight and a peak ratio of 0.5, and the battery of Example 5, which has a boron content of 0.01% by weight and a peak ratio of 0.5, showed a discharge capacity slightly smaller than that of Examples 1 to 3 but showed a high discharge capacity as compared with that of Comparative Example 3, which comprises a graphite free of boron. This, too, is attributed to the same reason as in Example 1.

The battery of Comparative Example 1, which has a boron content of 3.0% by weight and a peak ratio of 1.5, and the battery of Comparative Example 2, which has a boron -content of 1.5% by weight and a peak ratio of 1.5, showed a small discharge capacity. This is presumably because there is present a large amount of a boron compound film having an extremely low electronic conductivity that decreases the electronic conductivity between the negative active materials in the negative composite and between the negative active material and the current collector.

The battery of Comparative Example 3, which is free of boron, has no boron compound film having an extremely low electronic conductivity present therein. However, since no catalytic effect of boron is exerted in the stage of graphitization, the resulting graphite exhibits a lower crystallinity than graphite containing boron. Thus, the battery of Comparative Example 3 showed a low discharge capacity as compared with that of Examples 1 to 5.

The battery of Comparative Example 4, which has a boron content of 4.0% by weight and a peak ratio of 0.5, comprises a boron compound film having an extremely low electronic conductivity such as B₂O₃ adsorbed to the surface of the active material. The boron compound causes an increase of irreversible capacity during the initial stage of charging. Thus, the battery of Comparative Example 4 exhibited a low discharge capacity.

While the batteries of Examples 1 to 5 have been described with reference to the case where all negative active materials comprise a graphite containing boron, the aforementioned effect can be exerted also when the negative active material is partly made of boron. In this case, the amount of the graphite containing boron preferably accounts for 30% by weight or more based on the total weight of the negative active material.

As mentioned above, the non-aqueous electrolyte secondary battery of the invention comprises as a negative active material a boron-containing graphite containing little boron compound having an extremely low electronic conductivity and thus exhibits an enhanced discharge capacity.

While the invention has been described in detail and with reference to specific embodiments thereof, it will be apparent to one skilled in the art that various changes and modifications can be made therein without departing from the scope thereof.

This application is based on Japanese patent application No. 2001-130043 filed Apr. 26, 2001, the entire contents thereof being hereby incorporated by reference.

What is claimed is:

1. A non-aqueous electrolyte secondary battery comprising the following elements:
a positive electrode comprising a positive active material capable of absorbing/releasing lithium ion; and
a negative electrode comprising as a negative active material a graphite comprising boron having a S1/S2 ratio of about 1.0 or less wherein S1 is the area of the peak having its top at a range of from 188 to 192 eV and S2 is the area of the peak having its top at a range of from 185 to 187 eV as measured by X-ray photoelectron spectroscopy (XPS) and the content of boron in the graphite is from about 0.008% by weight to about 3% by weight.

2. The non-aqueous electrolyte secondary battery according to claim 1, wherein the positive active material is LiₓMO₂ wherein M represents one or more transition metals selected from the group consisting of Co, Ni and Mn, and x is from 0.1 to 1.2 (0.1≦×≦1.2).

3. The non-aqueous electrolyte secondary battery according to claim 1, wherein the positive active material is LiₓMn₂O₄ wherein x is from 0.1 to 1.2 (0.1≦×≦1.2).

4. The non-aqueous electrolyte secondary battery according to claim 1, wherein boron in the graphite is one derived from boric acid.

5. The non-aqueous electrolyte secondary battery according to claim 2, wherein boron in the graphite is one derived from boric acid.

6. The non-aqueous electrolyte secondary battery according to claim 3, wherein boron in the graphite is one derived from boric acid.

7. The non-aqueous electrolyte secondary battery according to claim 1, wherein the graphite is produced by subjecting pitch coke and boric acid to heat treatment in an inert atmosphere.

8. The non-aqueous electrolyte secondary battery according to claim 2, wherein the graphite is produced by subjecting pitch coke and boric acid to heat treatment in an inert atmosphere.

9. The non-aqueous electrolyte secondary battery according to claim 3, wherein the graphite is produced by subjecting pitch coke and boric acid to heat treatment in an inert atmosphere.

10. The non-aqueous electrolyte secondary battery according to claim 4, wherein the graphite is produced by subjecting pitch coke and boric acid to heat treatment in an inert atmosphere.

11. The non-aqueous electrolyte secondary battery according to claim 5, wherein the graphite is produced by subjecting pitch coke and boric acid to heat treatment in an inert atmosphere.

12. The non-aqueous electrolyte secondary battery according to claim 6, wherein the graphite is produced by subjecting pitch coke and boric acid to heat treatment in an inert atmosphere.
